(19) United States
(12) Patent Application Publication
(10) Pub. No.: US 2025/0023065 A1
(43) Pub. Date: Jan. 16, 2025

(54) SEPARATOR FOR FUEL CELL

(71) Applicants: Hyundai Motor Company, Seoul (KR); Kia Corporation, Seoul (KR)

(72) Inventors: Dong Gyun Kang, Seoul (KR); Woo Chul Shin, Suwon-si (KR); Sun Do Shin, Yongin-si (KR)

(21) Appl. No.: 18/496,551

(22) Filed: Oct. 27, 2023

(30) Foreign Application Priority Data
Jul. 10, 2023 (KR) 10-2023-0089320

(51) Int. Cl. H01M 8/0265; H01M 8/0263

(52) U.S. Cl. CPC H01M 8/0265; H01M 8/0263

(57) ABSTRACT

In an embodiment, a separator for a fuel cell includes a plurality of flow channels configured to flow gas or product water, and which are provided at a plurality of points with projections that project in first and second directions, wherein each of the plurality of flow channels is provided at set points thereof with a corresponding one of the projections but an adjacent flow channel is not provided with the projections at a point corresponding to the set point of the former flow channel, and some of the projections which project in one direction among the first and second directions are aligned on one straight line.

### CROSS-REFERENCE TO RELATED APPLICATIONS

This application claims the benefit of Korean Patent Application No. 10-2023-0089320, filed on Jul. 10, 2023, which application is hereby incorporated herein by reference.

### TECHNICAL FIELD

The present disclosure relates to a separator for a fuel cell.

### BACKGROUND

A fuel cell is a device that receives hydrogen and air from the outside and generates electrical energy as a result of electrochemical reaction in a fuel cell stack. The fuel cell may be used as a power source in various fields of fuel cell electric vehicles, fuel cells for electricity production, and the like.

A typical fuel cell system includes a fuel cell stack, in which a plurality of unit cells are stacked, a fuel supply system configured to supply hydrogen, and the like, which are the fuel for the fuel cell stack, an air supply system configured to supply oxygen, which is an oxidizing agent required in electrochemical reaction, a water and heat management system configured to control temperature of the fuel cell stack and the like.

When hydrogen is supplied to the anode of a fuel cell stack and oxygen is supplied to the cathode of the fuel cell stack, hydrogen ions and oxygen ions are generated by catalyst, and the hydrogen ions and the oxygen ions electrochemically react with each other, thereby creating electrical energy and water (product water).

A fuel cell stack is composed of hundreds of unit cells that are repeatedly stacked, and a unit cell includes an anode, a cathode, an electrolyte film, and a separator. Particularly, the separator has flow channels therein through which hydrogen and air flow. Design of the flow channels in the separator for improvement of performance of the fuel cell stack is in one of the critical fields.

Details described as the background art are intended merely for the purpose of promoting an understanding of the background of the present disclosure and should not be construed as an acknowledgment of the prior art that is already publicly known.

### SUMMARY

The present disclosure relates to a separator for a fuel cell constituting a unit cell of a fuel cell stack. Therefore, the present disclosure has been made in view of the above problems, and embodiments of the present disclosure can provide a separator for a fuel cell in which vertical flow of air between adjacent flow channels formed in the separator is established; thus allowing product water in the fuel cell stack to be easily discharged, residence time of gas introduced into the fuel cell stack increases, and utilization ratio of gas increases, thereby improving the performance of the fuel cell stack.

In accordance with an embodiment of the present disclosure, the above and other advantages can be accomplished by the provision of a separator for a fuel cell including a plurality of flow channels through which gas or product water flows, and which are provided at a plurality of points thereof with projections that project in first and second directions. In an embodiment, each of the plurality of flow channels can be provided at a preset, selected, or designed point thereof with a corresponding one of the projections but an adjacent flow channel is not provided with the projection at a point corresponding to the preset, selected, or designed point of the former flow channel, and some of the projections which project in one direction among the first and second directions are aligned on a same straight line.

In an embodiment, each of the projections may have a streamlined shape having no angle therein or an angled shape having two or more angles.

In an embodiment, a plurality of flow channels may include first flow channels, which are provided therein with projections that project in the first direction, and second flow channels, which are provided therein with projections that project in the second direction.

In an embodiment, the first flow channels and the second flow channels may be alternately arranged.

In an embodiment, projections provided in the first flow channels or projections provided in the second flow channels may be aligned on a same straight line.

In an embodiment, a plurality of flow channels may be defined between a plurality of land members, which project upwards while extending in a direction in which the plurality of flow channels extend and which are spaced apart from each other.

In an embodiment, a plurality of land members may include first land members at which projections are formed so as to project toward flow channels and second land members at which the projections are not formed.

In an embodiment, the first land members and the second land members may be alternately arranged.

In an embodiment, each of the first land members may have a straight-line shape, and each of the second land members may have a streamlined shape which is partially concave or convex.

In an embodiment, the first land members and the second land members may be arranged in a direction of gravity.

In an embodiment, the second land members may decrease in stages in surface area of projecting portions thereof moving toward a ground surface.

In an embodiment, portions of the second land members corresponding to the projections formed at the first land members may be provided therein with grooves which are depressed therefrom.

In an embodiment, projections may project toward the second land members such that part or all of the projections come into contact with the second land members.

In an embodiment, a portion of each of the projections may have a groove formed therein through which gas flows.

### BRIEF DESCRIPTION OF THE DRAWINGS

The above and other features and other advantages of an embodiment of the present disclosure can be more clearly understood from the following detailed description taken in conjunction with the accompanying drawings, in which:

FIG. 1 is a view illustrating a portion of a separator of a first embodiment of the present disclosure;

FIG. 2 is a view illustrating flow of air in a portion of the separator of the first embodiment of the present disclosure;

FIG. 3 is a view illustrating a cross-section of a separator of a second embodiment of the present disclosure;

FIG. 4 is a view illustrating a cross-section of a separator of a third embodiment of the present disclosure;

FIG. 5 is a view illustrating a cross-section of a separator of a fourth embodiment of the present disclosure;

FIG. 6 is a view illustrating a cross-section of a separator of a fifth embodiment of the present disclosure;

FIG. 7 is a view illustrating a cross-section of a separator of a sixth second embodiment of the present disclosure;

FIG. 8 is a view illustrating a cross-section of a separator of a seventh embodiment of the present disclosure; and

FIG. 9 is a view illustrating a cross-section of a separator of an eighth embodiment of the present disclosure.

### DETAILED DESCRIPTION OF ILLUSTRATIVE EMBODIMENTS

A description will now be given in detail according to exemplary embodiments disclosed herein, with reference to the accompanying drawings. For the sake of brevity of description with reference to the drawings, the same or equivalent components may be denoted by the same reference numbers, and a description thereof will not necessarily be repeated.

Furthermore, in the following description of embodiments disclosed herein, if it is decided that a detailed description of known functions or configurations related to the disclosure would make the subject matter of the disclosure unclear, such detailed description can be omitted. The accompanying drawings can be used to assist in easy understanding of various technical features, and it should be understood that the embodiments presented herein are not necessarily limited by the accompanying drawings. As such, the present disclosure can be construed to extend to any alterations, equivalents, and substitutes, in addition to those which are particularly set out in the accompanying drawings.

It can be understood that although the terms “first”, “second”, etc. may be used herein to describe various elements, these elements should not necessarily be construed as being limited by these terms. These terms can be merely used to distinguish one element from another. A singular representation may include a plural representation unless the context clearly indicates otherwise.

Terms such as “includes” or “has” used herein should be considered as indicating the presence of various features, numbers, steps, operations, elements, components, or combinations thereof, disclosed in the specification, and it should be understood that the presence or addition of one or more other features, numbers, steps, operations, elements, components, or combinations thereof, is not excluded.

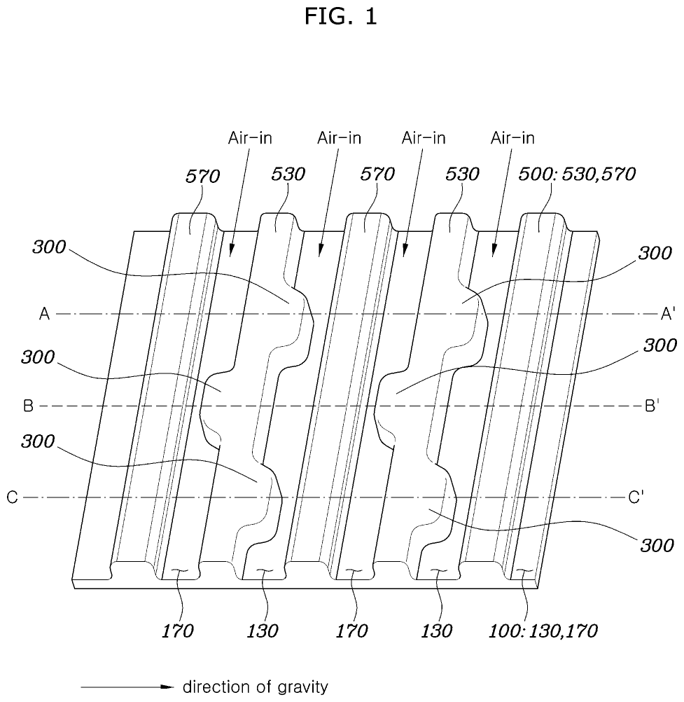

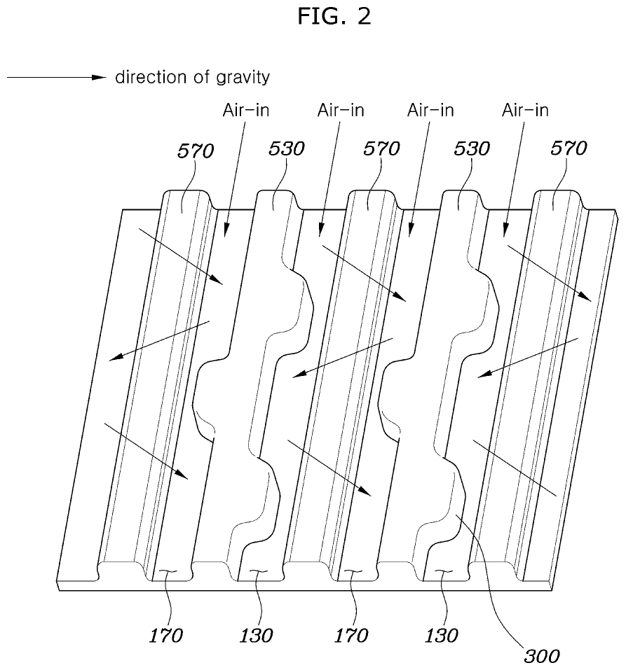

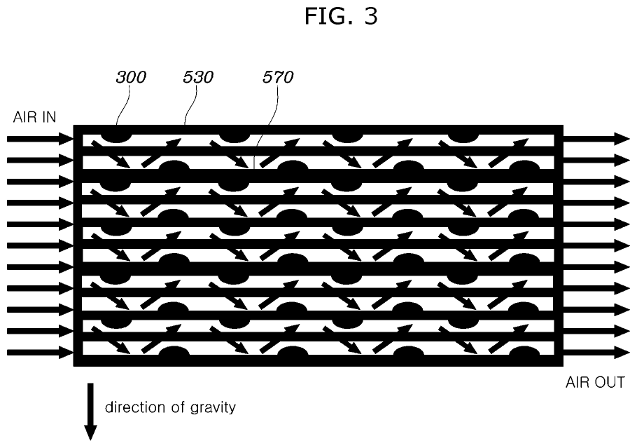

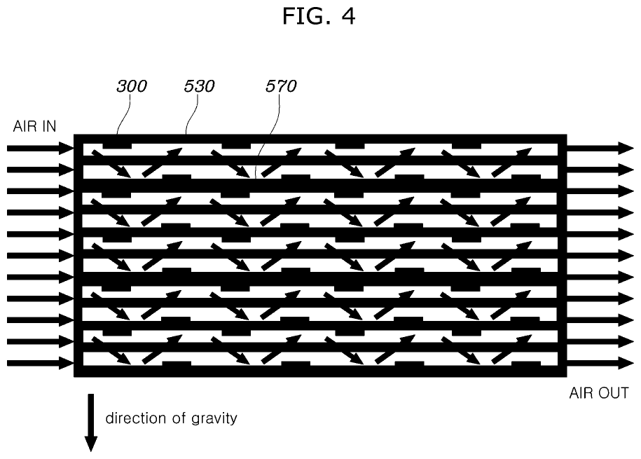

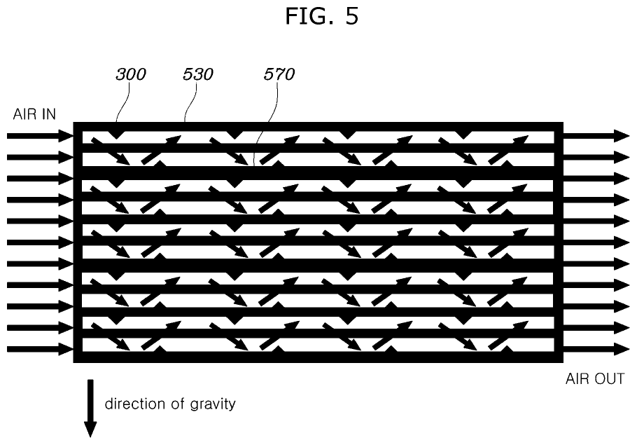

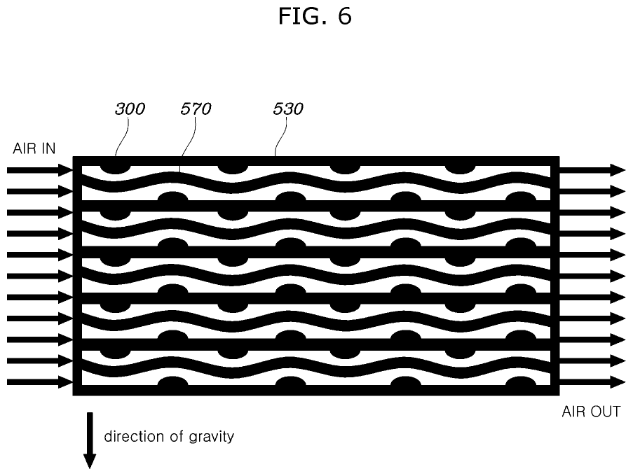

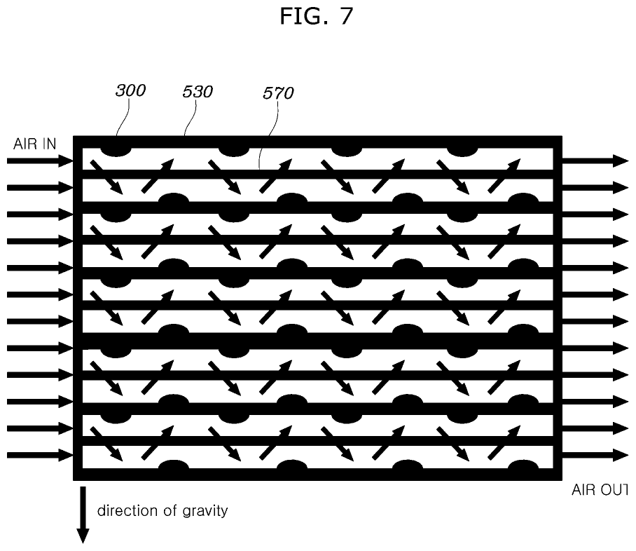

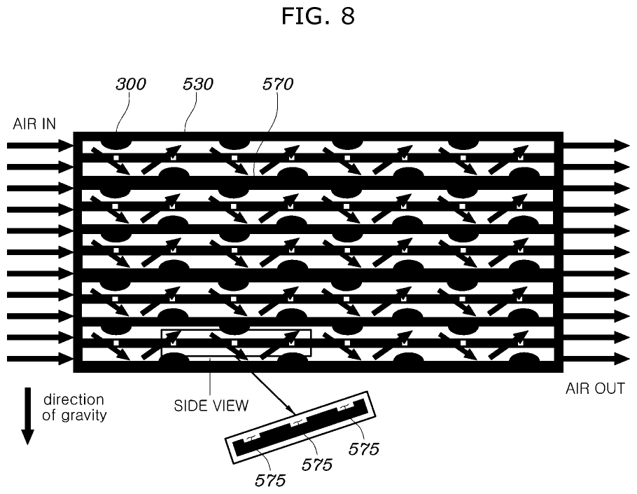

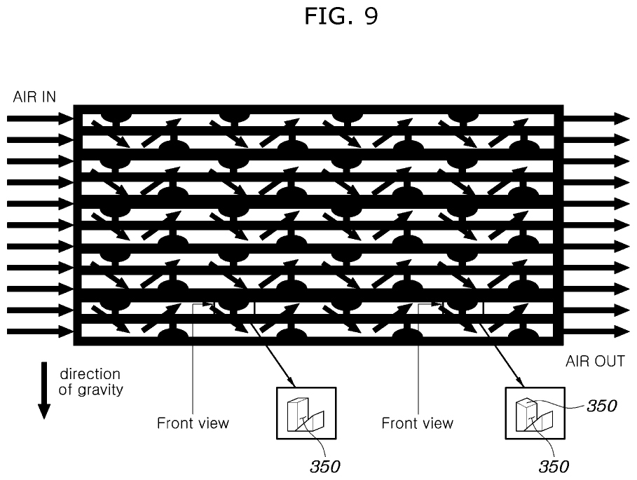

FIG. 1 is a view illustrating a portion of a separator of a first embodiment of the present disclosure. FIG. 2 is a view illustrating flow of air in a portion of the separator of the first embodiment of the present disclosure. FIG. 3 is a view illustrating a cross-section of a separator of a second embodiment of the present disclosure. FIG. 4 is a view illustrating a cross-section of a separator of a third embodiment of the present disclosure. FIG. 5 is a view illustrating a cross-section of a separator of a fourth embodiment of the present disclosure. FIG. 6 is a view illustrating a cross-section of a separator of a fifth embodiment of the present disclosure. FIG. 7 is a view illustrating a cross-section of a separator of a sixth second embodiment of the present disclosure. FIG. 8 is a view illustrating a cross-section of a separator of a seventh embodiment of the present disclosure. FIG. 9 is a view illustrating a cross-section of a separator of an eighth embodiment of the present disclosure.

For reference, FIGS. 2 to 8 illustrate the cross-sections of the separators when vertically erected relative to the ground.

The separator of an embodiment of the present disclosure, which is intended to achieve the above objects, can include a plurality of flow channels 100 through which gas or product water flows in a direction in which the separator extends and which includes a plurality of projections 300 projecting in one direction or in the opposite direction from a plurality of points. In an embodiment, a flow channel adjacent to a flow channel, which is provided with projections 300, is not provided with the projections 300, and the projections 300 which project in the same direction are positioned on a same straight line.

FIG. 1 illustrates a portion of a separator of a first embodiment of the present disclosure.

The separator of the first embodiment of the present disclosure is provided with a plurality of flow channels 100 through which gas, that is, air or hydrogen, and product water resulting from reaction of hydrogen with the oxygen in the air, can flow.

As illustrated in FIG. 1, specifically, the portion of the separator that is relatively depressed may define the flow channel 100, and the portion of the separator that relatively projects may define a side wall configured to guide flow of gas. Hereinafter, the gas can be assumed to be air, and embodiments of the present disclosure will be described based on flow of air.

The flow channel 100 is provided with the projection 300 that projects in one direction of the opposite direction. The projection 300 may be formed at the side wall of the flow channel, and the air that collides with the projection 300 may be reflected therefrom and then flow in the projecting direction of the projection 300. As illustrated in FIG. 2, the air that collides with the projection 300 may flow over the side wall and may be introduced into the adjacent flow channel 100. Consequently, the air may flow between the adjacent flow channels 100.

In other words, the projection 300 causes a portion of the air in the flow channel 100 to flow while having a wave shape, and causes a portion of the air in the flow channel 100 to flow into an adjacent flow channel to form vertical flow of the air between the adjacent flow channels 100.

In an embodiment, the projection 300 provided in one flow channel 100 projects in one direction or in the opposite direction such that one flow channel 100 is provided with only the projection 300 which projects in the one direction and an adjacent flow channel 100 is provided with the projection 300 which projects in the opposite direction. Accordingly, in an embodiment, there is no case in which both the projection which projects in the one direction and the projection which projects in the opposite direction are provided in one flow channel 100.

In other words, in an embodiment, the projection 300 is not provided at a point of one flow channel 100 corresponding to the point of an adjacent flow channel 100 at which the projection 300 is provided but is provided at a point of the one flow channel which is spaced apart from the projection which is provided in the adjacent flow channel 100. Referring to FIG. 1, specifically, when one projection 300 which projects in one direction is provided in one flow channel 100, another projection 300 which projects in the opposite direction is not provided at a point of an adjacent flow channel 100 corresponding to the one projection 300 but is provided at a point of the adjacent flow channel 100 which is spaced apart from the one projection 300.

In other words, in an embodiment, the projection 300 which projects in the one direction and the other projection 300 which projects in the opposite direction are provided at points which are spaced apart from each other in a diagonal direction.

As illustrated in FIG. 1, in an embodiment, the projections 300 that project in one direction are aligned on a same straight line A-A′, and the projections 300 which project in the opposite direction are also aligned on another same straight line B-B′. In other words, in an embodiment, the projections 300 that project in the same direction can be positioned on a same straight line. Referring to FIG. 1, in an embodiment, the projections 300 which project in one direction are aligned on line C-C′, and the projections 300 which project in the opposite direction are aligned on line B-B′.

Referring to FIGS. 1 and 2, the projections 300 which project in one direction are provided at a point of one flow channel 100 and at a corresponding point of a flow channel 100 next to a flow channel 100 adjacent to the one flow channel 100, and the projections 300 which project in the opposite direction are also provided at a point of one flow channel 100 and at a corresponding point of a flow channel 100 next to a flow channel 100 adjacent to the one flow channel 100.

As a result, in an embodiment, air reflected by the projection 300 can stably flow into an adjacent flow channel 100, thereby assuring smooth vertical movement between adjacent flow channels 100.

In other words, in an embodiment, if the projections 300 that project in a same direction are provided at a point of one flow channel 100 and at a corresponding point of an adjacent flow channel 100, the distance by which air moves vertically between the adjacent flow channels 100 increases. For this reason, in an embodiment, the projection 300 that projects in one direction and the projection 300 that projects in the opposite direction are provided at points of adjacent flow channels which are spaced apart from each other in a diagonal direction rather than being provided corresponding points of the adjacent flow channels 100.

Consequently, in an embodiment, the residence time for which air or hydrogen flows in the separator may increase, and the contact time between the separator and the air or hydrogen may increase by virtue of the increased residence time, thereby increasing the utilization ratio of the gas. As a result, for an embodiment, there can be an effect of improving the performance of a fuel cell stack.

For an embodiment, each of the projections 300 may be configured to have any of various shapes. The projection 300 according to a second embodiment may have a streamlined shape without an angled portion therein, as illustrated in FIG. 3. Meanwhile, the projection 300 may have an angled shape which has two or more angles therein, that is, a rectangular shape (a third embodiment) or a triangular shape (a fourth embodiment), as illustrated in FIGS. 4 and 5, respectively.

The shape of the projection 300 is not limited to the above-mentioned shapes, and the projection 300 of an embodiment may be configured to have any of shapes having two or more angles and a streamlined portion therein.

In an embodiment, as illustrated in FIGS. 1 and 2, the flow channels 100 are provided with two types of projections 300 which project in two directions. Among the flow channels 100, a flow channel 100 that is provided with projections 300 projecting in one direction is referred to as a first flow channel 130, and a flow channel 100 that is provided with projections 300 projecting in the opposite direction is referred to as a second flow channel 170.

In another expression manner of an embodiment, the flow channel 100 defined in the separator may include the first flow channels 130 and the second flow channels 170, and the first flow channels 130 and the second flow channels 170 may be alternately arranged. In other words, the first flow channels 130 which include projections 300 that project in one direction are alternately formed with the second flow channels 170 interposed therebetween.

As illustrated in FIG. 1, the projections 300 provided in the first flow channels 130 may be aligned on a same straight line (line A-A′ or line C-C′), and the projections 300 provided in the second flow channels 170 may also be aligned on another same straight line (line B-B′).

As shown in FIGS. 1 and 2, the side walls at which the projections 300 are formed may be referred to as land members 500. In an embodiment, the land members 500 relatively project upwards, and thus recessed portions, which are relatively depressed, are formed between the projecting land members 500 and serve as the flow channels 100. The plurality of land members 500 may be formed so as to be spaced apart from each other by a preset, selected, predetermined, or designed distance, thereby defining the flow channels 100 therebetween.

In an embodiment, as illustrated in FIGS. 1 and 2, the land members 500 include first land members 530, which are provided with the projections 300 that project toward the flow channels 100, and second land members 570, which are not provided with the projections 300. In an embodiment, like the first flow channels 130 and the second flow channels 170, which are alternately arranged, the first land members 530 and the second land members 570 may also be alternately arranged.

Referring to FIGS. 1 and 2, each of the first land members 530 include both the projections 300, which project in one direction, and the projections 300, which project in the opposite direction. The projections 300, which project in one direction, and the projections 300, which project in the opposite direction, are formed at the first land members 530 so as to be spaced apart from each other in the extension direction of the flow channels 100 in an alternating fashion.

Meanwhile, in an embodiment, each of the first land members 530 at which the projections 300 are formed may be configured to have a straight-line shape and each of the second land members 570 at which the projections 300 are not formed may be configured to have a streamlined shape that is partially concave or convex. In other words, referring to FIG. 6 illustrating a fifth embodiment of the present disclosure, because each of the second land members 570 at which the projections 300 are not formed has a streamlined shape (e.g., wave form shaped), it is possible to increase wave motion of air flowing in the flow channels and thus to further increase residence time of air.

In an embodiment, a fuel cell stack can be oriented such that a direction in which air and hydrogen are introduced is perpendicular to a direction of gravitational force. A reason for this is to allow product water that is created by the reaction between the air and the hydrogen to be moved toward the lower side of the fuel cell stack due to gravity.

Accordingly, the first land members 530 and the second land members 570, which are formed in the separator, can be arranged in the direction of gravitational force, and the flow channels defined by the first land members 530 and the second land members 570 can also be arranged in the direction of gravitational force.

According to a sixth embodiment of the present disclosure (see FIG. 7), the second land members 570 may be configured such that the projection heights of the second land members 570 decrease in stages moving toward the ground surface. Referring to FIG. 7 which illustrates a sixth embodiment of the present disclosure, it is noted that the surface areas of the second land member 570 decrease in stages moving in the direction of gravity.

When the surface areas of the second land members 570 decrease in a stepwise fashion moving toward the lower end from the upper end of the fuel cell stack, the friction between the product water collected on the lower end of the fuel cell stack due to gravity and the second land member 570 can be reduced, thereby offering an effect of facilitating discharge of the product water.

According to a seventh embodiment of the present disclosure (see FIG. 8), portions of the second land member 570 corresponding to the projections 300 formed at the first land member 530 may be provided therein with grooves 575, which are depressed therefrom. FIG. 8 illustrates the seventh embodiment of the present disclosure and an enlarged view of the second land member 570 (a side view of the second land member 570). Referring to FIG. 8, to allow the air reflected by the projections 300 formed at the first land member 530 to be more easily moved to an adjacent first land member 530, portions of the second land member 570 corresponding to the projections 300 of the adjacent first land member 530 may be provided therein with grooves 575, which are depressed therefrom.

In the seventh embodiment, because air can move to an adjacent flow channel 100 along the grooves 575 formed in the second land member 570, it is possible to further facilitate vertical movement of air between the flow channels 100 and thus to further increase residence time of air.

According to an eighth embodiment of the present disclosure (see FIG. 9), the projections 300 formed at the first land member 530 may project toward the second land member 570 such that part or all of the projections 300 formed at the first land member 530 come into contact with (or connects with) the second land member 570. Referring to FIG. 9, which illustrates the eighth embodiment of the present disclosure and enlarged views (front views) of the projections, the projections 300 project toward the second land member 570 from the first land member 530 such that the ends of the projections 300 come into contact with the second land member 570.

In the eighth embodiment, each of the projections 300 may be provided at a point thereof with a groove 350 through which gas flows. In other words, to allow gas to flow through the same flow channel, a portion of each of the projections 300, which comes into contact with the first land member 530 or the second land member 570, may be provided therein with the groove 350 such that the projection 300 blocks only a portion of the flow channel 100 and defines a narrow path therein.

Consequently, in the eighth embodiment, by virtue of the narrow path defined by the groove 350 formed in the projection, it is possible to improve flowability of air flowing through the same flow channel by virtue of the narrow path defined by the groove 350 formed in the projection 300.

As can be apparent from the above description, the separator of an embodiment of the present disclosure can offer advantages, in that vertical flow of air between adjacent flow channels formed in the separator can be established, thus allowing product water in the fuel cell stack to be easily discharged, and in that, residence time of gas introduced into the fuel cell stack can increase and utilization ratio of gas can thus increase, thus improving the performance of the fuel cell stack.

Although the embodiments of the present disclosure have been described above with reference to the accompanying drawings, those skilled in the art can appreciate that the present disclosure can be implemented in various other embodiments without changing the technical ideas or key features thereof.

What is claimed is:

1. A separator for a fuel cell comprising:
a plurality of flow channels configured to flow gas or product water through the separator, wherein the plurality of flow channels are provided at a plurality of points with projections that project in first and second directions,
wherein each of the plurality of flow channels is provided at a set point thereof with a corresponding one of the projections but an adjacent flow channel is not provided with the projection at a same point corresponding to the set point of a former flow channel, and some of the projections that project in one direction among the first and second directions are aligned on one straight line.

2. The separator of claim 1, wherein each of the projections has a streamlined shape having no angle therein or an angled shape having two or more angles.

3. The separator of claim 1, wherein the plurality of flow channels comprise:
first flow channels, wherein the first flow channels are provided therein with projections that project in the first direction; and
second flow channels, wherein the second flow channels are provided therein with projections that project in the second direction.

4. The separator of claim 3, wherein the first flow channels and the second flow channels are alternately arranged.

5. The separator of claim 4, wherein the projections provided in the first flow channels or the projections provided in the second flow channels are aligned on the one straight line.

6. The separator of claim 1, wherein the plurality of flow channels are defined between a plurality of land members, wherein the land members project upwards while extending in a direction in which the plurality of flow channels extend, and wherein the land members are spaced apart from each other.

7. The separator of claim 6, wherein the plurality of land members comprise:
first land members at which the projections are formed such that the projections project toward the flow channels; and
second land members at which the projections are not formed.

8. The separator of claim 7, wherein the first land members and the second land members are alternately arranged.

9. The separator of claim 7, wherein each of the first land members has a straight-line shape, and wherein each of the second land members has a streamlined shape that is partially concave or convex.

10. The separator of claim 7, wherein the first land members and the second land members are arranged in a direction of gravity.

11. The separator of claim 10, wherein the second land members decrease in stages in surface area thereof moving toward a ground surface.

12. The separator of claim 7, wherein portions of the second land members corresponding to the projections formed at the first land members are provided therein with grooves.

13. The separator of claim 7, wherein the projections project toward the second land members such that part or all of the projections contact the second land members.

14. The separator of claim 13, wherein a portion of each of the projections has a groove formed therein.

15. A separator for a fuel cell comprising:
a plurality of land members extending generally along a gas flow direction;
a plurality of flow channels formed between the plurality of land members; and
projections extending from a first set of the land members, the projections being located at a plurality of points along the flow channels, and the projections projecting into the flow channels in first and second directions;
wherein a first set of the projections extends in the first direction into a first set of the flow channels at a first set of the points;
wherein a second set of the flow channels, being located adjacent the first set of the flow channels, is not provided with any of the projections at the first set of the points;
wherein a second set of the projections extend in the second direction into the second set of the flow channels at a second set of the points; and
wherein the first set of the flow channels is not provided with any of the projections at the second set of the points.

16. The separator of claim 15, wherein each of the projections generally has a shape of a rounded hump, a rounded trapezoid, a rectangle, or a triangle.

17. The separator of claim 15, wherein a second set of the land members has a straight-line shape or a generally sinusoidal-wave shape.

18. The separator of claim 15, wherein at least some of the projections extend to and contact a second set of the land members.

19. The separator of claim 15, wherein a second set of the land members comprises grooves formed therein, the grooves being located opposite of and adjacent to the projections.

20. A separator for a fuel cell comprising:
a first land member extending generally along a first longitudinal direction;
a second land member extending generally along a gas flow direction, the second land member being separated from the first land member by a first flow channel;
a first set of projections extending from the first land member generally in a first lateral direction and extending into the first flow channel, the first lateral direction being generally perpendicular to the first longitudinal direction;
a third land member extending generally along the gas flow direction, the third land member being separated from the first land member by a second flow channel; and
a second set of projections extending from the first land member generally in a second lateral direction and extending into the second flow channel, the second lateral direction being generally perpendicular to the first longitudinal direction, and the second lateral direction being generally opposite of the first lateral direction.
